(19) United States
(12) Patent Application Publication
(10) Pub. No.: US 2015/0035326 A1
(43) Pub. Date: Feb. 5, 2015

(54) STABILIZING BICYCLE SEAT

(71) Applicants: Jon Wong, Long Beach, CA (US); Tom Peterson, Lakewood, WA (US)

(72) Inventors: Jon Wong, Long Beach, CA (US); Tom Peterson, Lakewood, WA (US)

(21) Appl. No.: 14/446,231

(22) Filed: Jul. 29, 2014

Related U.S. Application Data
(60) Provisional application No. 61/860,187, filed on Jul. 30, 2013.

(51) Int. Cl. B62J 1/28; A41D 13/00; B62J 1/00

(52) U.S. Cl. CPC B62J 1/28; B62J 1/007; A41D 13/0015
USPC 297/195.1

(57) ABSTRACT

A cyclist's desired position on a bicycle seat is maintained by a bicycle seat attachment, a replacement seat for either a new or used bicycle, or a bicycle seat system comprising a seat configured to cooperate in a variety of ways with a lower garment worn by the cyclist. The cyclist may be inhibited from moving forward or backward, left or right, or even up and down by a plurality of cooperative grooves, ridges, fins and catches in the seat or in conjunction with the seat and the lower garment.

### CROSS-REFERENCE TO RELATED APPLICATIONS

This application claims the benefit of U.S. Provisional Patent Application 61/860,187, filed on Jul. 30, 2013, and incorporated herein by reference.

### STATEMENT REGARDING FEDERALLY SPONSORED RESEARCH AND DEVELOPMENT

Not Applicable.

### FIELD OF THE INVENTION

This invention relates to bicycle seats, and more particularly to a stabilizing bicycle seat that provides increased power transfer from the cyclist to the bicycle.

### DISCUSSION OF RELATED ART

Serious bicycle athletes are concerned about using energy efficiently. For example, pedals with shoe clips allow the cyclist to add power on the upswing of the pedals to provide even more power and speed. Aerodynamic helmets and other accessories are common to reduce drag. However, heretofore no solutions exist for decreasing energy wasted by a cyclist trying to maintain a desired position on the bicycle's seat.

Frequently a cyclist will find himself having slid back on the seat and then must pull himself forward, utilizing energy in the process. Likewise, around turns a cyclist frequently finds himself shifting lateral position on the seat undesirably.

Therefore, there is a need for a bicycle seat attachment, replacement bicycle seat, or bicycle seat system that provides for inhibiting unwanted forward and rearward sliding of the cyclist on the seat, unwanted lateral movement of the cyclist on the seat, or a combination thereof. Such a needed invention would help the cyclist generate more power to the pedals through a more stable body-to-seat interface. Such a needed device would be relatively simple to install either on a new or used bicycle, and would be intuitive to use. Further, such a needed device would be relatively inexpensive to manufacture and lightweight. The present invention accomplishes these objectives.

### SUMMARY OF THE INVENTION

The present device is a bicycle seat attachment for use on a bicycle seat of a bicycle by a person. Some embodiments take the form of being integrated into a replacement seat of the bicycle. Further, some embodiments take the form of either a bicycle seat attachment or a replacement seat, either used in combination with a cooperative lower garment worn by the rider.

In a first embodiment, a base has a forward end adapted to buttress the posterior of the person. A clamping mechanism is fixed with the base and engages the bicycle seat around a rear end thereof. The clamping mechanism secures the base, preferably at a lower side thereof, between a top side of the seat and a bottom side of the seat. As such, with the clamping mechanism engaged with the seat, the person's posterior upon contacting the forward end of the base is prevented from further backward movement relative to the seat.

In a second embodiment of the invention, the bicycle seat attachment includes the base, a forward end, a rearward end, and a downwardly-projecting loop adapted to receive therein a forward thin portion of the bicycle seat. The rearward end terminates in an upwardly-raised flange adapted to buttress the posterior of the person. The forward end terminates in a resilient upwardly-projecting tongue. The base thereby forms a saddle for inhibiting forward and rearward motion in the seat by the person. Preferably the upwardly-projecting tongue is malleable and, as such, selectively angularly adjustable. Further, preferably the upper side of the base includes a plurality of laterally traversing ridges for inhibiting through friction backward and forward movement of the person while seated thereon.

In such an embodiment, the clamping mechanism is fixed to the rearward end of the base and the loop of the base. The clamping mechanism is adapted to retain the base onto the bicycle seat by pulling the loop of the base rearward towards the rearward end of the base through a length-adjustable strap. Preferably the clamping mechanism includes a rigid Y-shaped connector adapted to straddle a bicycle seat post while engaging the loop of the base at a forward end. The Y-shaped connector further provides a strap loop at a rear end thereof for engaging the strap therethrough.

In a third embodiment of the invention, a bottom side of a replacement seat is adapted for selective attachment to a bicycle seat post of the bicycle, as is known in the art. A top side of the seat is adapted for receiving the posterior of the person, and a rear side has at least one of the upwardly-projecting flanges adapted to buttress the posterior of the person. A forward side of the seat includes a central raised protrusion projecting upward and adapted to inhibit forward motion of the person while seated thereon. The protrusion is preferably made from a deformable, malleable material. The top side of the seat may further include a high-friction surface treatment, so that sliding movement thereon by the person is inhibited.

A forth embodiment of the invention includes a central longitudinal groove formed between a left half and a right half of the top side of the seat. Both sides of the seat are mutually resiliently deformable either towards or away from each other laterally, such that the person is inhibited from both forward or rearward movement while seated yet not inhibited in lateral movements from side to side.

A fifth embodiment of the invention is a bicycle seat system, comprising the bicycle seat that includes on the top side thereof a plurality of the laterally traversing ridges, and a lower garment worn by the person that has a posterior seat engagement portion that includes a plurality of grooves, each of which are adapted to receive one of the laterally traversing ridges of the seat. As such, when the person is seated on the seat while wearing the lower garment, the upwardly-extending ridges of the seat engage the grooves of the garment to inhibit forward and backward motion of the person while seated. The person, when elevated above the seat such as by standing on bicycle pedals, is free to adjust his position forward or backward with respect to the seat before sitting again on the seat at a more desired position.

In such an embodiment, the ridges of the seat may be sloped in a rearward direction and the grooves may be sloped in a forward direction, such that the bicycle seat system forms a ratchet mechanism between the seat and the lower garment. As such movement of the person forward is achievable by sliding forward, while rearward movement is prevented unless the person disengages the ridges from the grooves, such as by standing.

In one embodiment, the top side of the seat includes a left series of ridges and a right series of ridges, and the lower garment includes a left series of grooves and a right series of grooves. The left series of ridges and grooves are angled in a first direction, and the right series of ridges and grooves are angled in a second direction. As such, when the left series of ridges are engaged with the left series of grooves, and the when the right series of ridges are engaged with the right series of grooves, forward, rearward and lateral movement of the person is inhibited, unless the person disengages the ridges, from the grooves, such as by standing. Such an embodiment may be incorporated into a base for use with an existing bicycle seat, and fastened to the seat with straps, such as elastic or non-elastic straps, or may be integrally formed in a replacement bicycle seat.

In a seventh embodiment, the top side of the bicycle seat includes the longitudinal groove and the lower garment includes a downwardly-projecting fin from the posterior seat engagement portion. The fin may be curved from front to back, whereby when engaged with the longitudinal groove the person may adjust his angular position from forward to rearward in the seat while still being inhibited from lateral motion from side to side. As such, when the person is seated on the seat while wearing the lower garment, the fin of the garment engages the longitudinal groove of the seat to inhibit lateral motion of the person while seated.

In such an embodiment, the top side of the seat may further include the plurality of laterally-traversing ridges on both sides of the longitudinal groove, and the posterior seat engagement portion may further include a plurality of the grooves that are each adapted to receive one of the laterally traversing ridges of the seat. As such, when the person is seated on the seat while wearing the lower garment, the upwardly-extending ridges of the seat engage the grooves of the garment to inhibit forward and backward motion of the person while seated. The person when elevated above the seat is free to adjust his position forward or backward with respect to the seat before sitting again on the seat, the fin projecting away from the garment further than the ridges project away from the seat, so as to prevent lateral movement of the person with respect to the seat while still allowing the person to adjust his position forward or backward.

In an eighth embodiment of the invention, the posterior seat engagement portion of the lower garment includes a downwardly-projecting platform adapted for engagement with the longitudinal groove of the seat. A bottom side of the longitudinal groove may further include the plurality of laterally-traversing ridges, and the platform of the lower garment may further include the plurality of grooves each adapted to receive one of the laterally traversing ridges of the longitudinal groove. As such, when the person is seated on the seat while wearing the lower garment, the upwardly-extending ridges of longitudinal groove engage the grooves of the platform to inhibit forward and backward motion of the person while seated. When the person elevates his posterior slightly off of the seat, he is free to adjust his position forward or backward with respect to the seat before sitting again on the seat in a more preferred position.

In a ninth embodiment of the bicycle seat system, the longitudinal groove of the seat includes an upwardly-projecting longitudinal catch that has both a forward undercut and a rearward undercut. The posterior seat engagement portion of the lower garment projects downwardly and includes a groove therein that is adapted for engaging the longitudinal catch of the seat. The groove includes a forward undercut and a rearward undercut, each that cooperative with the forward and rearward undercuts, respectively, of the longitudinal catch to prevent upward movement of the person off of the seat when so engaged.

The present invention is a bicycle seat attachment, replacement bicycle seat, or bicycle seat system that provides for inhibiting unwanted forward and rearward sliding of the cyclist on the seat, unwanted lateral movement of the cyclist on the seat, or a combination thereof. The present system allows the cyclist to generate more power to the pedals through a more stable body-to-seat interface. The present invention is relatively simple to install either on a new or used bicycle, and is intuitive to use. Further, the present invention is relatively inexpensive to manufacture and lightweight. Other features and advantages of the present invention will become apparent from the following more detailed description, taken in conjunction with the accompanying drawings, which illustrate, by way of example, the principles of the invention.

### DESCRIPTION OF THE DRAWINGS

FIG. 1A is a top perspective view of a first embodiment of the invention;

FIG. 1B is a left-side elevational view of the embodiment of FIG. 1A;

FIG. 2A is a top perspective view of a second embodiment of the invention;

FIG. 2B is a bottom perspective view of the embodiment of FIG. 2B;

FIG. 3 is a top perspective view of a third embodiment of the invention;

FIG. 4 is a top perspective view of a fourth embodiment of the invention;

FIG. 5 is a top perspective view of a fifth embodiment of the invention;

FIG. 6A is a top perspective view of a sixth embodiment of the invention;

FIG. 6B is a bottom perspective view of the embodiment of FIG. 6B;

FIG. 7 is a top perspective view of a seventh embodiment of the invention;

FIG. 8 is a top perspective view of a eighth embodiment of the invention; and

FIG. 9 is a top perspective view of a ninth embodiment of the invention.

### DETAILED DESCRIPTION OF THE PREFERRED EMBODIMENT

Illustrative embodiments of the invention are described below. The following explanation provides specific details for a thorough understanding of and enabling description for these embodiments. One skilled in the art will understand that the invention may be practiced without such details. In other instances, well-known structures and functions have not been shown or described in detail to avoid unnecessarily obscuring the description of the embodiments.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below” and words of similar import, when used in this application, shall refer to this application as a whole and not to any particular portions of this application. When the claims use the word “or” in reference to a list of two or more items, that word covers all of the following interpretations of the word: any of the items in the list, all of the items in the list and any combination of the items in the list. When the word “each” is used to refer to an element that was previously introduced as being at least one in number, the word “each” does not necessarily imply a plurality of the elements, but can also mean a singular element.

The present invention can take the form of a bicycle seat attachment or accessory, a replacement seat for either a new or used bicycle, or a bicycle seat system comprising a seat configured to cooperate in a variety of ways with a lower garment worn by the cyclist.

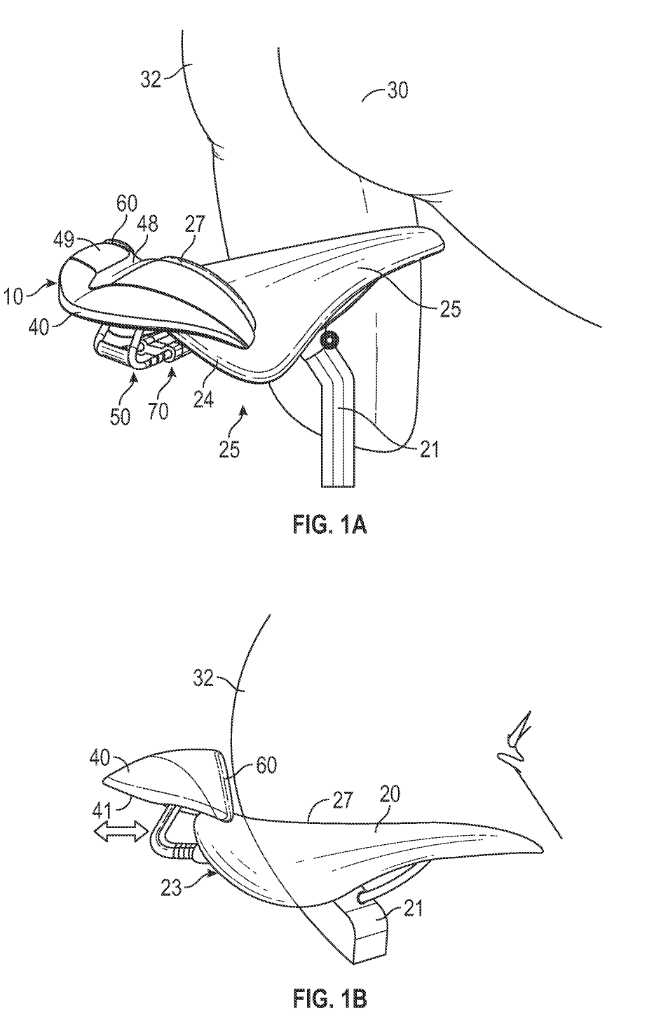

FIGS. 1A and 1B illustrate a bicycle seat attachment 10 for use on a bicycle seat 25 of a bicycle 20 by a person 30. A base 40 has a forward end 48 adapted to buttress the posterior 32 of the person 30. A clamping mechanism 50 is fixed with the base 40 and engages the bicycle seat 20 around a rear end 24 thereof. The forward end 48 of the base 40 may further include a cushion 60 for resilient engagement with the posterior 32 of the person 30. An upper side 49 of the base 40 is preferably curved downward from front to back and is relatively smooth, reducing aerodynamic drag on the base 40.

The clamping mechanism 50 secures the base 40, preferably at a lower side 41 thereof, between a top side 27 of the seat 20 and a bottom side 23 of the seat 20. The clamping mechanism 50 may include a threaded clamp bolt (not shown), or the like, to secure the base 40 to the seat 20. The clamping mechanism 50 may be resiliently fixed with the base 40, such as with a spring means 70, such that the base 40 may be moved forward and backward with respect to the seat 20 while the clamping mechanism retains the bicycle seat attachment 10 to the bicycle seat 20 and urges the base 40 towards a resiliently-neutral position with respect to the seat 20.

As such, with the clamping mechanism 50 engaged with the seat 20, the person's posterior 32 upon contacting the forward end 48 of the base 40 is prevented from further backward movement relative to the seat 20.

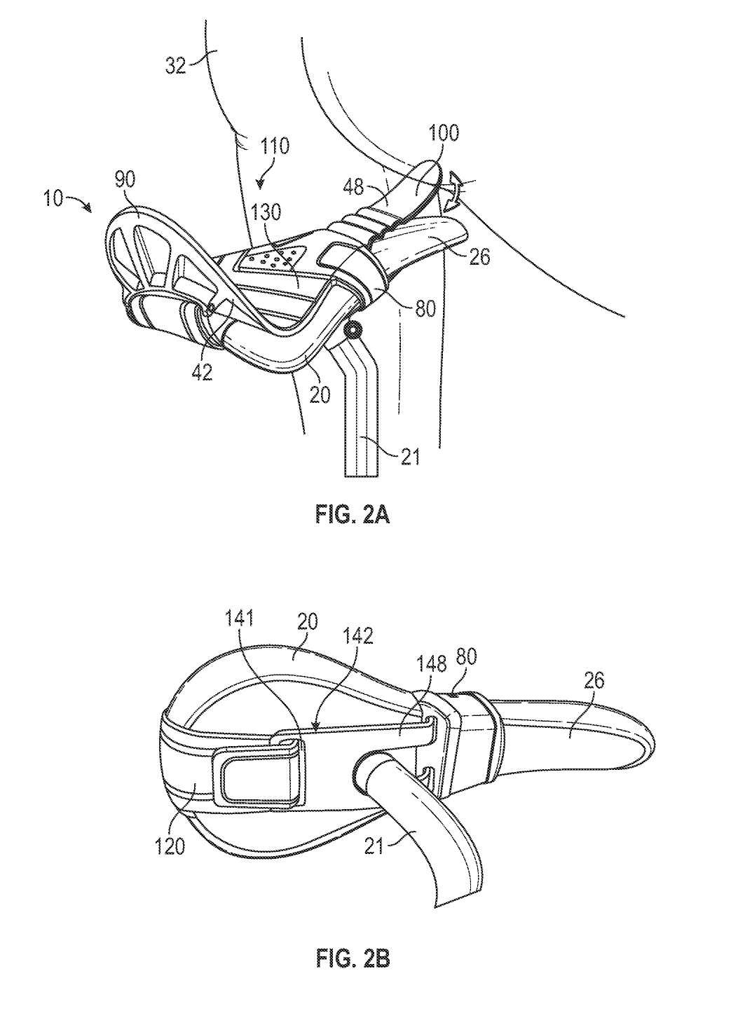

FIGS. 2A and 2B illustrate a second embodiment wherein the bicycle seat attachment 10 includes the base 40, a forward end 48, a rearward end 42, and a downwardly-projecting rigid loop 80 adapted to receive therein a forward thin portion 26 of the bicycle seat 20. The rearward end 42 terminates in an upwardly-raised flange 90 adapted to buttress the posterior 32 of the person 30. The forward end 42 terminates in a resilient upwardly-projecting tongue 100. The base 40 thereby forms a saddle 110 for inhibiting forward and rearward motion in the seat 20 by the person 30. Preferably the upwardly-projecting tongue 100 is malleable and, as such, selectively angularly adjustable. Further, preferably the upper side 49 of the base 40 includes a plurality of laterally traversing ridges 130 for inhibiting through friction backward and forward movement of the person 30 while seated thereon.

In such an embodiment, the clamping mechanism 50 is fixed to the rearward end 42 of the base 40 and the loop 80 of the base 40. The clamping mechanism 50 is adapted to retain the base 40 onto the bicycle seat 40 by pulling the loop 80 of the base 40 rearward towards the rearward end 42 of the base 40 through a length-adjustable strap 120. Preferably the clamping mechanism 50 includes a rigid Y-shaped connector 140 adapted to straddle a bicycle seat post 21 while engaging the loop 80 of the base 40 at a forward end 148. The Y-shaped connector 140 further provides a strap loop 141 at a rear end 142 thereof for engaging the strap 120 therethrough.

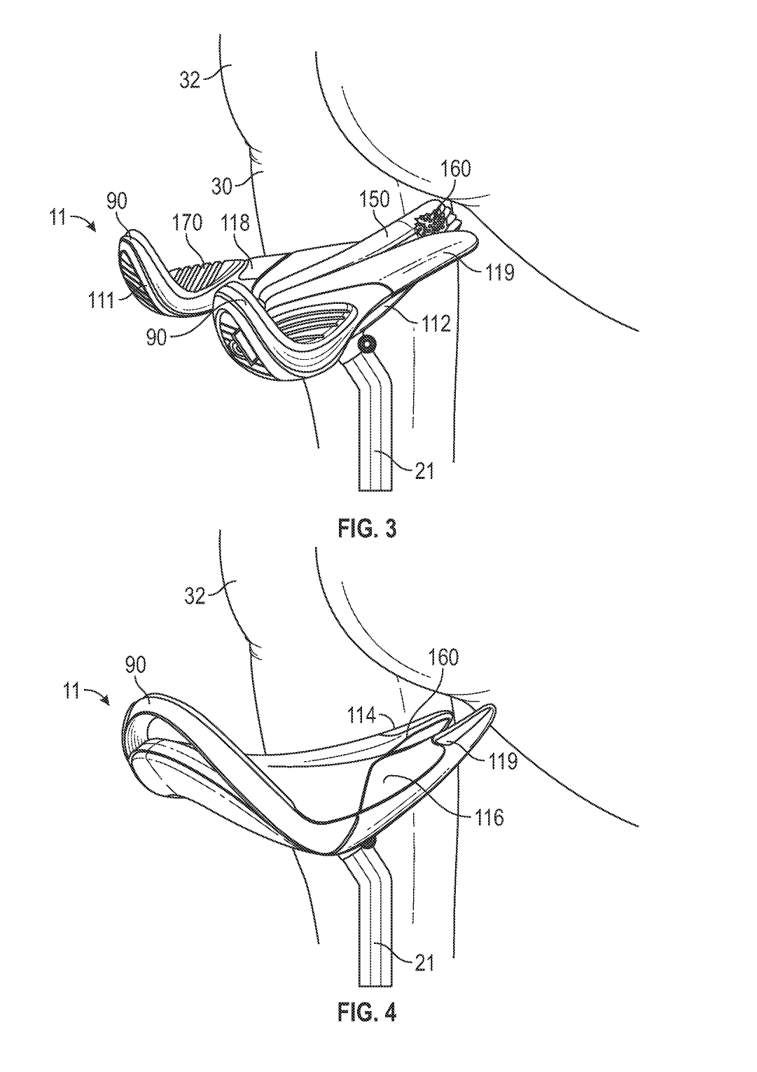

FIG. 3 illustrates a bicycle seat 11 embodiment of the invention, wherein a bottom side 112 of the seat 11 is adapted for selective attachment to a bicycle seat post 21 of the bicycle 20, as is known in the art. A top side 118 of the seat 11 is adapted for receiving the posterior 32 of the person 30, and a rear side 111 has at least one of the upwardly-projecting flanges 90 adapted to buttress the posterior 32 of the person 30. A forward side 119 of the seat 11 includes a central raised protrusion 150 projecting upward and adapted to inhibit forward motion of the person 30 while seated thereon. The protrusion 150 is preferably made from a deformable, malleable material, and may include a gel material 160 therein for allowing the deformable protrusion 150 to conform to the shape of the person 30. Such a gel material 160 may be essentially rigid at room temperature, but when heated, such as in a microwave, may become pliable so as to be custom shaped for the person 30. The top side 118 of the seat 11 may further include a high-friction surface treatment 170, so that sliding movement thereon by the person is inhibited. Further, the raised protrusion 150 and high friction surface treatment 170 may be made with a gel material that becomes more tacky as it is heated by frictional contact with the person's clothing.

FIG. 4 illustrates a bicycle seat 11 wherein a central longitudinal groove 160 is formed between a left half 114 and a right half 116 of the top side 118 of the seat 11. Both sides 114,116 of the seat 11 are mutually resiliently deformable either towards or away from each other laterally, such that the person 30 is inhibited from both forward or rearward movement while seated yet not inhibited in lateral movements from side to side, due to the resiliency of each side 114,116 of the seat 11 with respect to the other. The top side 118 of the seat 11 may further include a high-friction surface treatment 170, so that sliding movement thereon by the person is inhibited.

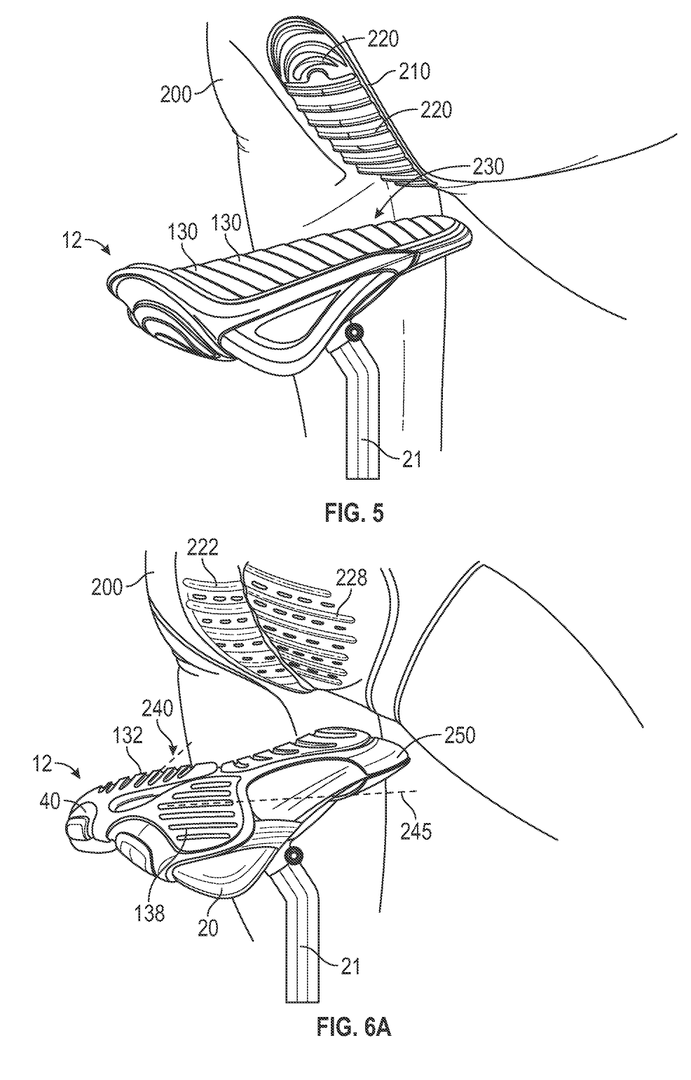

FIG. 5 illustrates a bicycle seat system 12, comprising the bicycle seat 11 that includes on the top side 118 thereof a plurality of the laterally traversing ridges 130.

A lower garment 200 worn by the person 20 has a posterior seat engagement portion 210 that includes a plurality of grooves 220, each of which are adapted to receive one of the laterally traversing ridges 130 of the seat 11.

As such, when the person is seated on the seat 11 while wearing the lower garment 200, the upwardly-extending ridges 130 of the seat 11 engage the grooves 220 of the garment 200 to inhibit forward and backward motion of the person 20 while seated. The person 20, when elevated above the seat 11 such as by standing on pedals (not shown), is free to adjust his position forward or backward with respect to the seat 11 before sitting again on the seat 11 at a more desired position.

In such an embodiment, the ridges 130 of the seat 11 may be sloped in a rearward direction and the grooves 220 may be sloped in a forward direction, such that the bicycle seat system 12 forms a ratchet mechanism 230 between the seat 11 and the lower garment 200. As such movement of the person 20 forward is achievable by sliding forward, while rearward movement is prevented unless the person 20 disengages the ridges 130 from the grooves 220, such as by standing. Alternately, the ridges 130 of the seat 11 may be sloped in a forward direction and the grooves 220 may be sloped in a rearward direction, such that the bicycle seat system 12 forms an oppositely-directed ratchet mechanism 230 between the seat 11 and the lower garment 200. As such movement of the person 20 rearward is achievable by sliding rearward, while forward movement is prevented unless the person 20 disengages the ridges 130 from the grooves 220, such as by standing. In one embodiment (not shown), some of the ridges 130 are sloped one way and the rest are sloped the other way, such that both forward and backward movement is inhibited unless the person 20 stands to reposition himself on the seat 11.

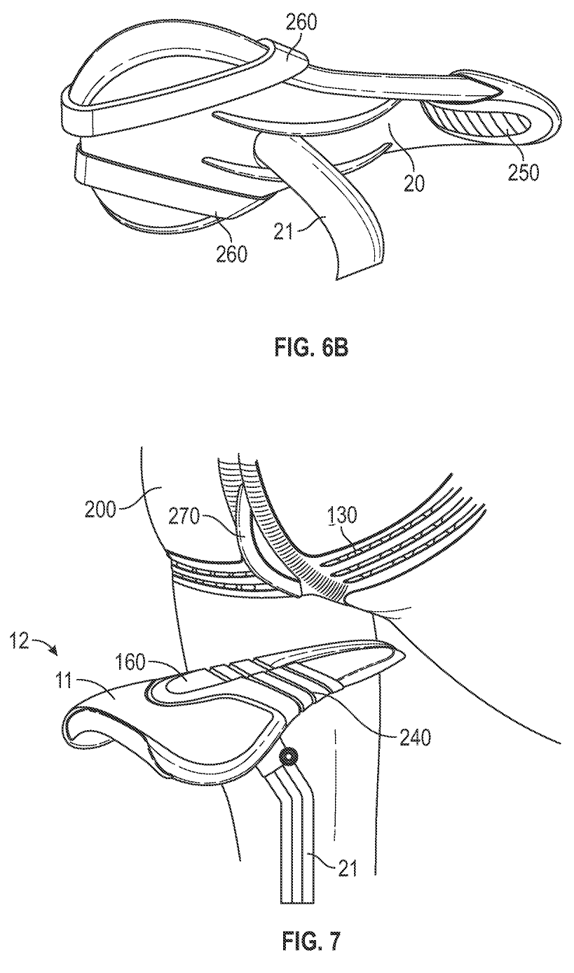

In one embodiment, illustrated in FIGS. 6A and 6B, the top side 118 of the seat 11 includes a left series of ridges 132 and a right series of ridges 138, and the lower garment 200 includes a left series of grooves 222 and a right series of grooves 228. The left series of ridges 132 and grooves 222 are angled in a first direction 240, and the right series of ridges 138 and grooves 228 are angled in a second direction 245. As such, when the left series of ridges 138 are engaged with the left series of grooves 222, and the when the right series of ridges 138 are engaged with the right series of grooves 228, forward, rearward and lateral movement of the person is inhibited, unless the person 20 disengages the ridges 132,138 from the grooves 222,228, such as by standing. Such an embodiment may be incorporated into a base 40 for use with an existing bicycle seat 20, and fastened to the seat with straps 260, such as elastic straps 260 as illustrated in FIGS. 6A and 6B, or may be integrally formed in a bicycle seat 11 (not shown).

In a seventh embodiment, illustrated in FIG. 7, the top side 118 of the bicycle seat 11 includes the longitudinal groove 160 and the lower garment includes a downwardly-projecting fin 270 from the posterior seat engagement portion 210. The fin 270 may be curved from front to back, whereby when engaged with the longitudinal groove 160 the person 30 may adjust his angular position from forward to rearward in the seat 11 while still being inhibited from lateral motion from side to side. As such, when the person 30 is seated on the seat 11 while wearing the lower garment 200, the fin 270 of the garment 200 engages the longitudinal groove 160 of the seat 20 to inhibit lateral motion of the person 30 while seated. In one embodiment, the fin 270 is selectively detachable from the lower garment 200, such as with a tongue-in-groove arrangement (not shown), or snap-in friction fit connection (not shown), or the like.

In such an embodiment, the top side 118 of the seat 11 may further include the plurality of laterally-traversing ridges 130 on both sides of the longitudinal groove 160, and the posterior seat engagement portion 210 may further include a plurality of the grooves 220 that are each adapted to receive one of the laterally traversing ridges 130 of the seat 11. As such, when the person 20 is seated on the seat 11 while wearing the lower garment 200, the upwardly-extending ridges 130 of the seat 11 engage the grooves 220 of the garment 200 to inhibit forward and backward motion of the person 30 while seated. The person 30 when elevated above the seat 118 is free to adjust his position forward or backward with respect to the seat 11 before sitting again on the seat 11, the fin 270 projecting away from the garment 200 further than the ridges 130 project away from the seat 118, so as to prevent lateral movement of the person 30 with respect to the seat 11 while still allowing the person to adjust his position forward or backward before sitting down again on the seat 11 in a more preferred position.

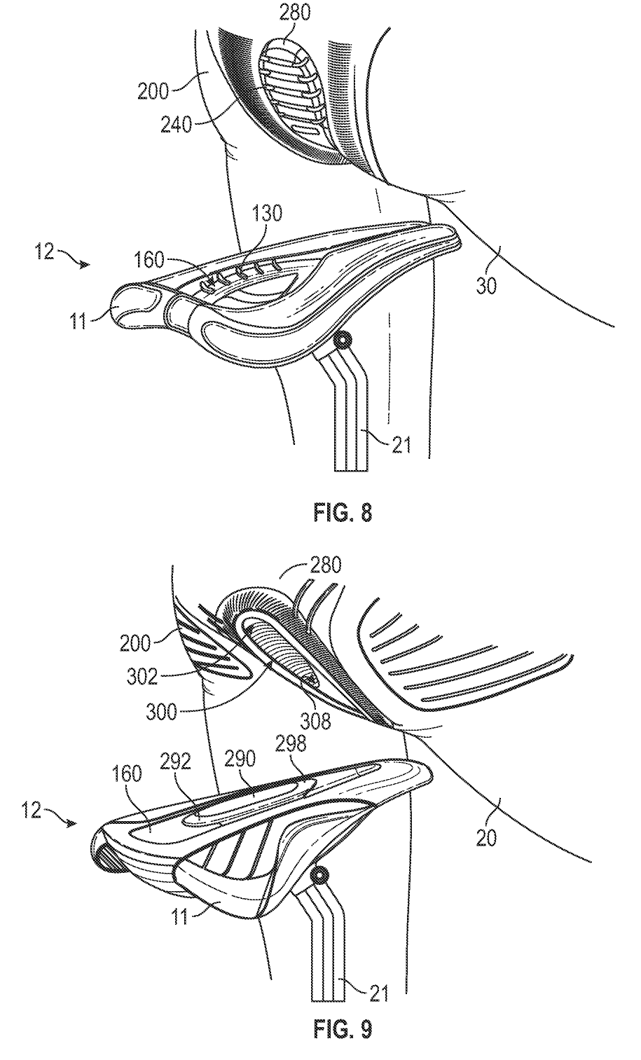

In an eighth embodiment of the invention, illustrated in FIG. 8, the posterior seat engagement portion 210 of the lower garment 200 includes a downwardly-projecting platform 280 adapted for engagement with the longitudinal groove 160 of the seat 11. A bottom side 162 of the longitudinal groove 160 may further include the plurality of laterally-traversing ridges 130, and the platform 280 of the lower garment 200 may further include the plurality of grooves 220 each adapted to receive one of the laterally traversing ridges 130 of the longitudinal groove 160. As such, when the person 30 is seated on the seat 11 while wearing the lower garment 200, the upwardly-extending ridges 130 of longitudinal groove 160 engage the grooves 220 of the platform 280 to inhibit forward and backward motion of the person 30 while seated. When the person 30 elevates his posterior 32 slightly off of the seat 11, he is free to adjust his position forward or backward with respect to the seat 11 before sitting again on the seat 11 in a more preferred position. The platform 280 projects away from the garment 220 further than the ridges 130 project away from the seat 11 so as to prevent lateral movement of the person 30 with respect to the seat 11 while still allowing the person 30 to adjust his position forward or backward before sitting down again on the seat 11.

In a ninth embodiment of the bicycle seat system 12, illustrated in FIG. 9, the longitudinal groove 160 of the seat 11 includes an upwardly-projecting longitudinal catch 290 that has both a forward undercut 298 and a rearward undercut 292. The posterior seat engagement portion 210 of the lower garment 200 projects downwardly and includes a groove 300 therein that is adapted for engaging the longitudinal catch 290 of the seat 11. The groove 300 includes a forward undercut 308 and a rearward undercut 302, each that cooperative with the forward and rearward undercuts 298,292 respectively, of the longitudinal catch 290 to prevent upward movement of the person 30 off of the seat 11 when so engaged. When the groove 300 of the lower garment 200 is centered on the longitudinal catch 290 the undercuts 292,298 and 302,308 clear each other to allow the lower garment 200 and the person 30 to raise himself off of the seat 11. Preferably the upwardly-projecting longitudinal catch 290 projects upwardly from the seat 11 no further than the top side 118 of the seat 11.

In the embodiment shown in FIG. 9, the catch 290 is aligned longitudinally with the seat 11 and only one catch 290 is shown. However, in alternate embodiments (not shown) there may be a plurality of catches 290, each smaller than shown in FIG. 9 and arranged along the seat 11 such that the person 30 may select any particular catch 290 to “clip into” with a corresponding groove 300. Moreover, the catches 290 may be oriented transversely to the seat 11 as well.

While a particular form of the invention has been illustrated and described, it will be apparent that various modifications can be made without departing from the spirit and scope of the invention. Accordingly, it is not intended that the invention be limited, except as by the appended claims.

Particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention.

The above detailed description of the embodiments of the invention is not intended to be exhaustive or to limit the invention to the precise form disclosed above or to the particular field of usage mentioned in this disclosure. While specific embodiments of, and examples for, the invention are described above for illustrative purposes, various equivalent modifications are possible within the scope of the invention, as those skilled in the relevant art will recognize. Also, the teachings of the invention provided herein can be applied to other systems, not necessarily the system described above. The elements and acts of the various embodiments described above can be combined to provide further embodiments.

All of the above patents and applications and other references, including any that may be listed in accompanying filing papers, are incorporated herein by reference. Aspects of the invention can be modified, if necessary, to employ the systems, functions, and concepts of the various references described above to provide yet further embodiments of the invention.

Changes can be made to the invention in light of the above “Detailed Description.” While the above description details certain embodiments of the invention and describes the best mode contemplated, no matter how detailed the above appears in text, the invention can be practiced in many ways. Therefore, implementation details may vary considerably while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated.

While certain aspects of the invention are presented below in certain claim forms, the inventor contemplates the various aspects of the invention in any number of claim forms. Accordingly, the inventor reserves the right to add additional claims after filing the application to pursue such additional claim forms for other aspects of the invention.

What is claimed is:

1. A bicycle seat attachment for use on a bicycle seat of a bicycle by a person, comprising:
a base having a forward end adapted to buttress the posterior of the person;
a clamping mechanism fixed with the base, the clamping mechanism engaging the bicycle seat around a rear end thereof and securing the base between a top side and a bottom side of the seat;
whereby with the clamping mechanism engaged with the seat, the person's posterior upon contacting the forward end of the base is prevented from further backward movement relative to the seat.

2. The bicycle seat attachment of claim 1 wherein the forward end of the base includes a cushion for resilient engagement with the posterior of the person.

3. The bicycle seat attachment of claim 1 wherein the base is fixed with the clamping mechanism at a lower side thereof.

4. The bicycle seat attachment of claim 3 wherein an upper side of the base is curved downward from front to back and is relatively smooth, whereby aerodynamic drag is reduced by the base.

5. The bicycle seat attachment of claim 1 wherein the base is resiliently fixed with the clamping mechanism, such that the base may be moved forward and backward with respect to the seat while the clamping mechanism retains the bicycle seat attachment to the bicycle seat.

6. The bicycle seat attachment of claim 1 wherein the base frictionally and slidably attaches to the bicycle seat in cooperation with the clamping mechanism, the clamping mechanism including a spring means for allowing the base to slide forward and backward along the seat while urging the base towards a resiliently-neutral position.

7. A bicycle seat attachment for use on a bicycle seat of a bicycle by a person, comprising:
a base have a forward end, a rearward end, and a downwardly-projecting rigid loop, the loop adapted to receive therein a forward thin portion of the bicycle seat, the rearward end terminating at an upwardly-raised flange adapted to buttress the posterior of the person, the forward end terminating in a resilient upwardly-projecting tongue, the base thereby forming a saddle for inhibiting forward and rearward motion in the seat by the person;
a clamping mechanism fixed to the rearward end of the base and the loop of the base, the clamping mechanism adapted to retain the base onto the bicycle seat by pulling the loop of the base rearward toward the rearward end of the base through a length-adjustable strap.

8. The bicycle seat attachment of claim 7 wherein the upwardly-projecting tongue of the base is selectively angularly adjustable.

9. The bicycle seat attachment of claim 8 wherein a upper side of the base includes a plurality of laterally traversing ridges for inhibiting through friction backward and forward movement of the person while seated thereon.

10. The bicycle seat attachment of claim 7 wherein the clamping mechanism includes a rigid Y-shaped connector adapted to straddle a bicycle seat post while engaging the loop of the base at a forward end and providing a strap loop at a rear end for engaging the strap therethrough.

11. A bicycle seat for use on a bicycle by a person, comprising a bottom side adapted for selective attachment to a bicycle seat post of the bicycle, a top side adapted for receiving the posterior of the person, a rear side having at least one upwardly-projecting flange adapted to buttress the posterior of the person, and a forward side including a central raised protrusion projecting upward and adapted to inhibit forward motion of the person while seated thereon, the protrusion being made with a deformable material.

12. The bicycle seat of claim 11 wherein the deformable protrusion includes a malleable gel material contained therein for allowing the deformable protrusion to conform to the shape of the person.

13. The bicycle seat of claim 12 wherein the gel material is rigid at room temperature but pliable when heated.

14. The bicycle seat of claim 11 wherein the top side of the seat further includes a high-friction surface treatment, whereby sliding movement thereon by the person is inhibited.

15. A bicycle seat for use on a bicycle by a person, comprising a bottom side adapted for selective attachment to a bicycle seat post of the bicycle, a top side adapted for receiving the posterior of the person, a rear side having at least one upwardly-projecting flange adapted to buttress the posterior of the person, and a forward side including a central raised protrusion projecting upward and adapted to inhibit forward motion of the person while seated thereon, a central longitudinal groove formed between a left and right half of the top side of the seat, both sides of the seat mutually resiliently deformable either towards or away from each other, whereby the person is inhibited from both forward or rearward movement while seated yet not inhibited in lateral movements from side to side due to the resiliency of each side of the seat with respect to the other.

16. The bicycle seat of claim 15 wherein the top side of the seat further includes a high-friction surface treatment, whereby sliding movement thereon by the person is inhibited.

17. A bicycle seat system for use on a bicycle by a person, comprising:
a bicycle seat comprising a bottom side adapted for selective attachment to a bicycle seat post of the bicycle, a top side adapted for receiving the posterior of the person, a rear side having at least one upwardly-projecting flange adapted to buttress the posterior of the person, and a forward side, the top side including a plurality of laterally traversing ridges; and
a lower garment worn by the person and having a posterior seat engagement portion having a plurality of grooves each adapted to receive one of the laterally traversing ridges of the seat;
whereby when the person is seated on the seat while wearing the lower garment, the upwardly-extending ridges of the seat engage the grooves of the garment to inhibit forward and backward motion of the person while seated, the person when elevated above the seat being free to adjust his position forward or backward with respect to the seat before sitting again on the seat.

18. The bicycle seat system of claim 17 wherein the ridges of the seat are sloped in a rearward direction and the grooves of the garment are sloped in a forward direction, the bicycle seat system forming a ratchet mechanism whereby movement of the person forward is achievable by sliding forward, but rearward movement is prevented unless the person disengages the ridges from the grooves.

19. The bicycle seat system of claim 17 wherein the ridges of the seat are sloped in a forward direction and the grooves of the garment are sloped in a rearward direction, the bicycle seat system forming a ratchet mechanism whereby movement of the person rearward is achievable by sliding rearward, but forward movement is prevented unless the person disengages the ridges from the grooves.

20. The bicycle seat system of claim 17 wherein the top side of the seat includes a left series of ridges and a right series of ridges, and wherein the lower garment includes a left series of grooves and a right series of grooves, the left series of ridges and grooves angled in a first direction and the right series of ridges and grooves angled in a second direction, such that when the left series of ridges are engaged with the left series of grooves, and when the right series of ridges are engaged with the right series of grooves, forward, rearward and lateral movement of the person is inhibited.

21. A bicycle seat system for use on a bicycle seat of a bicycle by a person, comprising:
a base having a forward end terminating in a downwardly-projecting nose adapted to capture a forward end of the bicycle seat, a top side adapted for receiving the posterior of the person, the top side including a plurality of laterally-traversing upwardly-projecting ridges;
a clamping mechanism fixed with the rearward end of the base and adapted to retain the base onto the bicycle seat by pulling the nose of the forward end toward the rearward end of the base through at least one elastic strap; and
a lower garment worn by the person and having a posterior seat engagement portion having a plurality of grooves each adapted to receive one of the laterally traversing ridges of the top side of the base;
whereby when the person is seated on the base while wearing the lower garment, the upwardly-extending ridges of the base engage the grooves of the garment to inhibit forward and backward motion of the person while seated, the person when elevated above the seat being free to adjust his position forward or backward with respect to the base before sitting again on the base.

22. The bicycle seat system of claim 21 wherein the ridges of the base are sloped in a rearward direction and the grooves of the garment are sloped in a forward direction, the bicycle seat system forming a ratchet mechanism whereby movement of the person forward is achievable by sliding forward on the base, but rearward movement is inhibited unless the person disengages the ridges from the grooves.

23. The bicycle seat system of claim 21 wherein the ridges of the base are sloped in a forward direction and the grooves of the garment are sloped in a rearward direction, the bicycle seat system forming a ratchet mechanism whereby movement of the person rearward is achievable by sliding rearward on the base, but forward movement is inhibited unless the person disengages the ridges from the grooves.

24. The bicycle seat system of claim 21 wherein the top side of the base includes a left series of ridges and a right series of ridges, and wherein the lower garment includes a left series of grooves and a right series of grooves, the left series of ridges and grooves both angled in a first direction and the right series of ridges and grooves both angled in a second direction, such that when the left series of ridges are engaged with the left series of grooves, and when the right series of ridges are engaged with the right series of grooves, forward, rearward and lateral movement of the person is inhibited.

25. A bicycle seat system for use on a bicycle by a person, comprising:
a bicycle seat comprising a bottom side adapted for selective attachment to a bicycle seat post of the bicycle, a top side adapted for receiving the posterior of the person and including a longitudinal groove; and
a lower garment worn by the person and having a posterior seat engagement portion having a projecting fin adapted for engaging the longitudinal groove of the seat;
whereby when the person is seated on the seat while wearing the lower garment, the fin of the garment engages the longitudinal groove of the seat to inhibit lateral motion of the person while seated.

26. The bicycle seat system of claim 25 wherein the fin is curved from front to back, whereby when engaged with the longitudinal groove the person may adjust his angular position from forward to rearward in the seat while still being inhibited from lateral motion.

27. The bicycle seat system of claim 25 wherein the top side of the seat further includes a plurality of laterally-traversing ridges on both sides of the longitudinal groove, and wherein the posterior seat engagement portion further includes a plurality of grooves each adapted to receive one of the laterally traversing ridges of the seat;
whereby when the person is seated on the seat while wearing the lower garment, the upwardly-extending ridges of the seat engage the grooves of the garment to inhibit forward and backward motion of the person while seated, the person when elevated above the seat being free to adjust his position forward or backward with respect to the seat before sitting again on the seat, the fin projecting away from the garment further than the ridges project away from the seat so as to prevent lateral movement of the person with respect to the seat while still allowing the person to adjust his position forward or backward before sitting down again on the seat.

28. A bicycle seat system for use on a bicycle by a person, comprising:
a bicycle seat comprising a bottom side adapted for selective attachment to a bicycle seat post of the bicycle, a top side adapted for receiving the posterior of the person and including a longitudinal groove; and
a lower garment worn by the person and having a posterior seat engagement portion having a downwardly-projecting platform adapted for engaging the longitudinal groove of the seat;
whereby when the person is seated on the seat while wearing the lower garment, the platform of the garment engages the longitudinal groove of the seat to inhibit lateral motion of the person while seated.

29. The bicycle seat of claim 28 wherein a bottom side of the longitudinal groove further includes a plurality of laterally-traversing ridges, and wherein the platform of the posterior seat engagement portion further includes a plurality of grooves each adapted to receive one of the laterally traversing ridges of the seat;
whereby when the person is seated on the seat while wearing the lower garment, the upwardly-extending ridges of the longitudinal groove engage the grooves of the platform to inhibit forward and backward motion of the person while seated, the person when elevated above the seat being free to adjust his position forward or backward with respect to the seat before sitting again on the seat, the platform projecting away from the garment further than the ridges project away from the seat so as to prevent lateral movement of the person with respect to the seat while still allowing the person to adjust his position forward or backward before sitting down again on the seat.

30. A bicycle seat system for use on a bicycle by a person, comprising:
a bicycle seat comprising a bottom side adapted for selective attachment to a bicycle seat post of the bicycle, a top side adapted for receiving the posterior of the person and including a longitudinal groove that includes an upwardly-projecting longitudinal catch having both forward and rearward undercuts; and
a lower garment worn by the person and having a downwardly-projecting posterior seat engagement portion having a groove therein adapted for engaging the longitudinal catch of the seat, the groove including a forward and rearward undercut that cooperates with the forward and rearward undercuts of the longitudinal catch;
whereby when the person is seated on the seat while wearing the lower garment, the groove of the garment engages the longitudinal catch of the seat to inhibit lateral motion of the person while seated, and limiting forward and rearward motion of the person while seated between the forward and rearward catches of the longitudinal catch.

31. The bicycle seat system of claim 30 wherein the upwardly-projecting longitudinal catch projects upwardly no further than the top side of the seat.
